(19) United States
(12) Patent Application Publication
(10) Pub. No.: US 2020/0224135 A1
(43) Pub. Date: Jul. 16, 2020

(54) CONTAINER SYSTEM FOR AGING BEVERAGES AND METHOD OF MAKING AND USING SAME

(71) Applicant: James Call, San Diego, CA (US)

(72) Inventor: James Call, San Diego, CA (US)

(73) Assignee: James Call, San Diego, CA (US)

(21) Appl. No.: 16/740,318

(22) Filed: Jan. 10, 2020

Related U.S. Application Data
(60) Provisional application No. 62/791,550, filed on Jan. 11, 2019.

(51) Int. Cl. C12H 1/22; B65D 47/00; B65D 25/10; B65D 77/04

(52) U.S. Cl. CPC C12H 1/22; B65D 77/0493; B65D 25/10; B65D 47/00

(57) ABSTRACT

A container system for aging beverages in a barrel and making and using it are disclosed. The system includes a container body having a first portion and a second portion each having an inner surface. The first portion and the second portion are selectively connected to enclose the barrel and form a space between an outer surface of the barrel and the inner surfaces of the first and second portions of the container body. The container body has at least one opening for inputting into the space and withdrawing from the space a medium.

### RELATED APPLICATION

This application claims priority to U.S. Provisional patent application, Application No. 62/791,550, entitled CONTAINER SYSTEM FOR AGING BEVERAGES AND METHOD OF MAKING AND USING SAME filed Jan. 11, 2019, incorporated herein by reference in its entity.

### FIELD OF THE INVENTION

The field of the invention in general relates to containers for aging liquids, such as beverages, and methods of making and using them.

### BACKGROUND OF THE INVENTION

There is no admission that the background art disclosed in this section legally constitutes prior art.

Presently, many beverages and other food products are aged in wooden casks or barrels as part of the production process. These wooden casks are of various sizes, such as one common size that contains around 53 gallons of liquid. Beverages include alcoholic beverages such as wine and beer, and nonalcoholic beverages such as coffee and tea. Distilled beverages such as whiskey, scotch and bourbon are also aged in wood casks or barrels. For bourbon production, the requirement is that distilled (ethanol) alcohol from a corn mixture must be aged in virgin (new) oak casks for at least two years and a day. Typically, the casks are made of American white oak wood. Scotch and whisky are also aged in oak casks that are not necessarily virgin. Many manufacturers purchase used bourbon casks to age their products in to add flavor profiles.

Various factors determine the flavor and color of the end product including the environment and length of time aging in the cask. For example, the aging process is greatly influenced by the type of oak used, the char level applied (burning of the inside of the cask prior to filling), and the air temperature and humidity the cask is exposed to in the warehouse as it ages.

As part of the aging process, a portion of the liquid is lost through evaporation of alcohol and water through the wood of the cask, and the proof (alcohol-by-volume) of the beverage will drop slightly. The amount of this evaporation, known as the Angel's Portion, depends on temperature and humidity and can range from around 2% to 25% of the volume of liquid in the cask per year. Regarding the temperature environment, warm climates can cause faster reactions, and the aging will cause changes more quickly but more harshly, occasionally removing desirable components as well. Because wood is a porous product, barrels can “breathe,” expelling gas during the day when the temperature is warmer, and drawing gas in at night when the temperature is cooler. This breathing process causes the liquid to circulate and allow the wood to add flavoring to the aging beverage, but aging beverages in uncontrolled temperature environments may add uncertainty to the time required and the amount of flavors added into the beverage. In order to better control these environmental conditions, barrels are usually stored in rackhouses or underground cellars where temperatures can be regulated and climate changes minimized.

Further, the use of wooden barrels can create other issues during the aging process. For example, wooden barrels are flammable, and are often stored in large numbers (often, many thousands) in huge warehouses, and so present a significant fire risk. If a fire does occur, the cost to the manufacturer can be significant. For example, in 2018 a fire in a single warehouse in Kentucky destroyed over 20,000 barrels of bourbon (around 3.5 million bottles), thus costing the bourbon maker millions of dollars.

Thus, it would be highly desirable for a method of aging beverages that is impervious to most external weather conditions and be stored outside of a normal aging warehouse to allow wider temperature fluctuations to impact the aging process. There is also a need for a beverage aging system that can recapture evaporated alcohol to be condensed and form a secondary product from the aging process. Further, there is a need for a beverage aging system that can reduce the fire danger due to the presence of wooden casks.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is an exploded view of a container system for aging beverages, which is constructed in accordance with an embodiment of the invention;

FIG. 2 is a sectional view of the container system of FIG. 1; and

FIG. 3 is a sectional view of the container system of FIG. 2 taken along lines 3-3 thereof.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

A container system according to an embodiment may be used for aging a liquid contained in a barrel. The container system includes a container body having a first portion and a second portion each having an inner surface. The first portion and the second portion are selectively connected to enclose the barrel and form a space between an outer surface of the barrel and the inner surfaces of the first and second portions of the container body. The container body has at least one opening for inputting into the space and withdrawing from the space a medium.

Another embodiment of the container system includes at least one spacer attached to at least one inner surface of the first and second portions. Further embodiments of the system include an environmental control unit for controlling the temperature of the liquid and/or an agitator for agitating the liquid. In another embodiment, the container system includes a pressure gauge for measuring the pressure of the space.

A method of making a container according to an embodiment may be used for aging a liquid contained in a barrel. The method of making includes providing a container body having a first portion and a second portion each having an inner surface, wherein the first portion connects to the second portion for fully enclosing the barrel and forming a space between an outer surface of the barrel and the inner surfaces of the first and section portions of the container body. The method also includes providing at least one opening in the container body for inputting into the space and withdrawing from the space a medium.

In an embodiment, the method of making also includes providing one or more spacers for attaching to at least one inner surface of the first and second portions. Another embodiment of the method includes providing an environmental control unit for controlling the temperature of the liquid. A further embodiment includes providing an agitator for agitating the liquid. Yet another embodiment includes providing a pressure gauge for measuring the pressure of the space.

A method of using a container according to an embodiment may be used for aging a liquid contained in a barrel. The method of using includes the steps of inserting a barrel into a lower portion of a container body; connecting an upper portion of the container body to the lower portion to fully enclose the barrel and form a space between an outer surface of the barrel and inner surfaces of the upper and lower portions of the container body; and inputting a medium into the space from at least one opening in the container body.

In another embodiment, the method of using includes extracting a medium from the at least one opening in the container body. In yet another embodiment, the method of using includes attaching one or more spacers to at least one inner surface of the first and second portions. An embodiment further includes controlling the temperature of the liquid with an environmental control unit attached to the container body. Another embodiment includes agitating with an agitator disposed in the barrel.

Therefore, a container system for aging beverages is provided that is impervious to most external weather conditions and can be stored outside of a normal aging warehouse to allow wider temperature fluctuations to impact the aging process. Further, the container system for aging beverages can recapture evaporated alcohol to be condensed and form a secondary product from the aging process. Moreover, the container system for aging beverages is provided that is sturdy and reusable, and can reduce the fire danger due to the presence of the wooden casks.

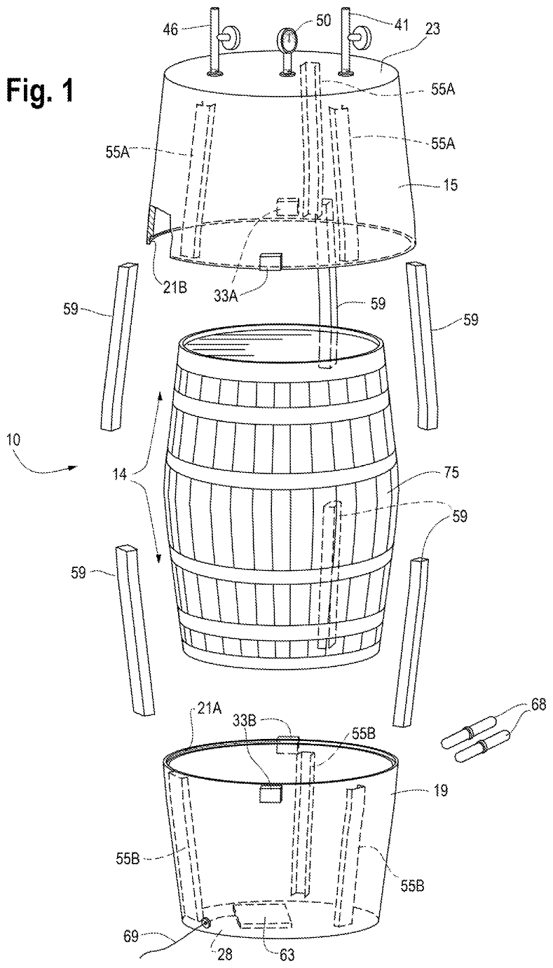

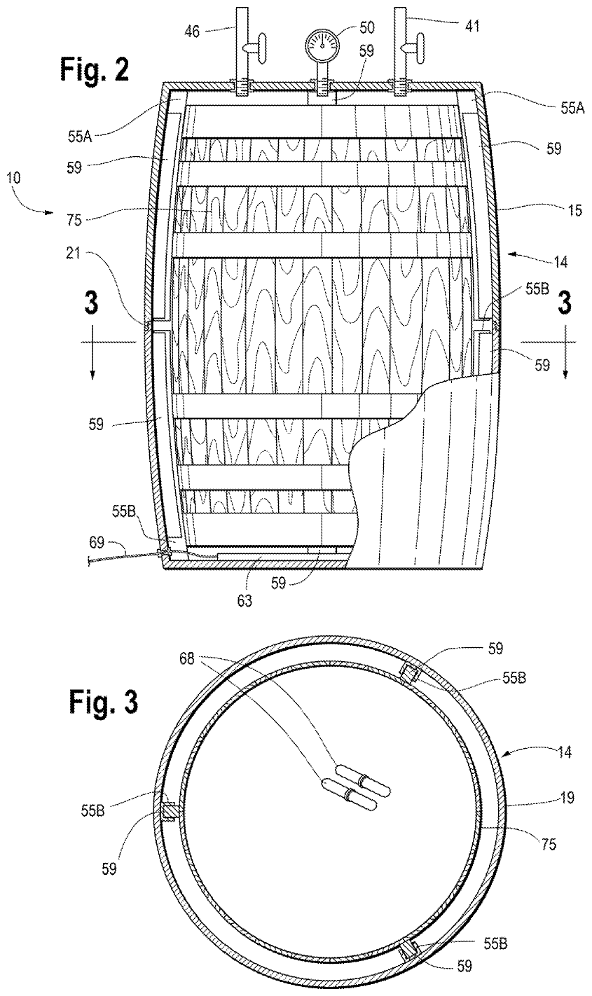

Referring now to the drawings, and more particularly to FIGS. 1-3, there is shown a container system for aging beverages 10, which may be constructed in accordance with an embodiment. As illustrated in FIGS. 1-3, the container system 10 includes a container body 14 having an upper portion 15, a top portion 23, a lower portion 19 and a bottom portion 28. The upper portion 15 may be selectively connected to a lower portion 19 by a screw element 21 including a male portion 21A and a female portion 21B so that the seal of the container body 14 is airtight. A latch apparatus 33 including upper portions 33A and lower portions 33B may be employed in lieu of or in addition to the screw element 21.

The container system 10 may also include one or more input/out valves such as input valve 41 and output valve 46 that allow the insertion and extraction of gases or other mediums into a space formed between the container body 14 sealed around a barrel 75.

In an embodiment, the container body 14 is generally barrel-shaped in order to conformally enclose a beverage aging container such as an oak barrel. In other embodiments, the container body 14 may be various shapes such as square, rectangular, round or others so that the container body 14 completely encloses the barrel 75 with an airtight seal. The container body 14 may comprise a suitable rigid material such as metal, plastic, composite or other suitable material. The container body 14 should be sturdy enough to provide support for the enclosed barrel 75 and to be stored in a warehouse or other industrial environment.

The container body 14 may also include one or more spacer channels 55A on an inner surface of the container body upper portion 15 and one or more spacer channels 55B on an inner surface of the container body lower portion 19. In an embodiment, the channels 55A and 55B may comprise a generally rectangular tube shape comprising three sides and having one open side. The spacer channels 55A and 55B are sized to hold a spacer 59 that is inserted into the channels. In an embodiment, one or more other spacers 59 may be employed located on an inner portion of the container body top portion 23 and an inner portion of the container body bottom portion 28. The spacer channels 55A and 55B and the spacers 59 may comprise a suitable rigid matter such as metal, plastic, wood, composite or other suitable material. The spacer channels 55A and 55B and the spacers 59 may be slightly curved in shape to substantially conform to the shape of the barrel 75.

The container system 10 may also include one or more input/out valves such as an input valve 41 and an output valve 46 disposed through the inner portion of the container body 14 for allowing insertion or extraction of gases or other mediums into the space located between the barrel 75 and the container body 14. The pressure of the gases located in the space may be measured by a pressure gauge 50 disposed through the container body top portion 23. In an embodiment, gases, such as air, oxygen or inert gases such as nitrogen may be inserted through the input valve 41 at normal atmospheric pressure or elevated into the space atmospheric pressures to control the amount of alcohol that evaporates out of the barrel 75. The output valve 46 may be used to extract some or substantially all of the gases located in the space to form a vacuum. Such a vacuum may accelerate the aging process of the liquid and enhance the flavor over a shorter time period than conventional techniques.

The container system 10 may also include an environmental control unit 63 that may be disposed on an inner portion of the container body bottom portion 28. The unit 63 provides heating and cooling to the barrel 75 to control the temperature of the liquid aging therein. The unit 63 may include an electric cord 69 for providing electric power.

The container system 10 may further include one or more agitators 68 that are inserted into the barrel 75 for agitating the liquid while undergoing the aging process. The one or more agitators 68 help to ensure that the liquid does not stagnate in the barrel which would result in more flavoring occurring in the liquid in closer proximity to the inside of the barrel 75. In an embodiment, the agitators 68 may comprise one or more magnetic stirring bars that can be operated and programmed by a user with a remote control to circulate the liquid within the barrel for even temperature throughout the liquid.

For use of the container system 10, spacers 59 are inserted into the channels 55A and 55B, a spacer 59 and an environmental control unit 63 are disposed on the inner portion of the container body bottom portion 28, and a spacer is disposed on the inner portion of the container body top portion 23. If desired, one or more agitators 68 are disposed within the barrel 75. Next, the barrel 75 is positioned inside the container body lower portion 19 and secured by the spacers 59 located therein. This step may be accomplished while the container body lower portion 19 is in a horizontal position, a vertical position, or other suitable position. Then, the container body upper portion 23 is placed over the barrel 75 and onto the lower portion 19 and secured by engaging the male portion 21A of the screw element 21 with the female portion 21B with a twist of around 15 degrees so that the seal is airtight. Finally, the upper portions 33A and lower portions 33B of the latch apparatus 33 may be engaged to further provide an airtight fit. Also, an optional strap may be positioned around the container body 14 where the upper portion 23 engages the lower portion 19 to further ensure an airtight seal.

After an airtight seal is created, the input valve 41 allows insertion of gases such as air, oxygen or inert gases such as nitrogen into the space outside of the barrel 75 at normal or elevated atmospheric pressures to control the amount of evaporating alcohol and the output valve 46 allows extraction of some or substantially all of the gases located in the space to form a vacuum. The pressure of the gases located in the space may be measured by a pressure gauge 50, and in an embodiment, the pressure may be provided up to around three atmospheres. The temperature of the liquid in the barrel 75 may be controlled by the environmental control unit 63.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. A container system for aging a liquid contained in a barrel, comprising:
a container body having a first portion and a second portion each having an inner surface;
wherein the first portion and the second portion are selectively connected to enclose the barrel and form a space between an outer surface of the barrel and the inner surfaces of the first and second portions of the container body; and
wherein the container body has at least one opening for inputting into the space and withdrawing from the space a medium.

2. The container system of claim 1, wherein the system further comprises at least one spacer attached to at least one inner surface of the first and second portions.

3. The container system of claim 1, wherein the system further comprises an environmental control unit for controlling the temperature of the liquid.

4. The container system of claim 1, wherein the system further comprises an agitator for agitating the liquid.

5. The container system of claim 1, wherein the system further comprises a pressure gauge for measuring the pressure of the space.

6. A method of making a container for aging a liquid contained in a barrel, comprising:
providing a container body having a first portion and a second portion each having an inner surface;
wherein the first portion connects to the second portion for fully enclosing the barrel and forming a space between an outer surface of the barrel and the inner surfaces of the first and second portions of the container body; and
providing at least one opening in the container body for inputting into the space and withdrawing from the space a medium.

7. The method of claim 6, wherein the method further comprises providing one or more spacers for attaching to at least one inner surface of the first and second portions.

8. The method of claim 6, wherein the method further comprises providing an environmental control unit for controlling the temperature of the liquid.

9. The method of claim 6, wherein the method further comprises providing an agitator for agitating the liquid.

10. The method of claim 6, wherein the method further comprises providing a pressure gauge for measuring the pressure of the space.

11. A method of using a container for aging a liquid contained in a barrel, comprising:
inserting a barrel into a lower portion of a container body;
connecting an upper portion of the container body to the lower portion to fully enclose the barrel and form a space between an outer surface of the barrel and inner surfaces of the upper and lower portions of the container body; and
inputting a medium into the space from at least one opening in the container body.

12. The method of claim 11, wherein the method further comprises extracting a medium from the at least one opening in the container body.

13. The method of claim 11, wherein the method further comprises attaching one or more spacers to at least one inner surface of the first and second portions.

14. The method of claim 11, wherein the method further comprises controlling the temperature of the liquid with an environmental control unit attached to the container body.

15. The method of claim 11, wherein the method further comprises agitating with an agitator disposed in the barrel.
